(19) United States
(12) Patent Application Publication
(10) Pub. No.: US 2013/0112899 A1
(43) Pub. Date: May 9, 2013

(54) RADIATION PROTECTIVE SLAT ARRANGEMENT

(71) Applicants: Juergen Schulz, Riemerling (DE); Barbara Ballsieper, Munchen (DE)

(72) Inventors: Juergen Schulz, Riemerling (DE); Barbara Ballsieper, Munchen (DE)

(73) Assignee: MAVIG GMBH, Munchen (DE)

(21) Appl. No.: 13/509,701

(22) PCT Filed: Nov. 15, 2010
(86) PCT No.: PCT/EP10/67437

§ 371 Date: May 14, 2012

(30) Foreign Application Priority Data
Nov. 17, 2009 (DE) 10 2009 053 619.1

(51) Int. Cl. G21F 3/00

(52) U.S. Cl. CPC G21F 3/00
USPC 250/517.1

(57) ABSTRACT

The present invention relates to a radiation protective slat arrangement comprising a guide and several radiation protective slats movably arranged along the guide. The arrangement can be converted from an open state into a closed state by displacing and rotating the slats. Adjacent slats are arranged to overlap each other and are articulated to each other.

The present invention relates to a radiation protective slat arrangement, in particular for shielding the X-ray radiation emitted by an X-ray radiation source used, for example, in radioscopy.

In order to keep the radiation exposure caused by radioscopy as low as possible for the people involved, it is practice, i.a. on account of the established regulations, to design X-ray rooms such that no radiation or only a minimum thereof escapes. To this end, usually radiopaque materials are used for building the X-ray room.

Furthermore, various kinds of X-ray protective devices are known. DE 1 959 358 A, for example, discloses a radiation protection against X-rays in the form of a radiation protective curtain on an adjustable mounting. The radiation protective curtain consists of several strips which are arranged side by side, overlap each other and may contain, for example, lead. The mounting comprises a supporting bar for the radiation protective curtain, said bar being attached so as to be longitudinally movable and preferably fixable in any position. The supporting bar may be configured flexibly and may optionally be pivotably connected to a rail.

Moreover, DE 27 49 826 A1 discloses an X-ray shielding system comprising individual slats arranged at a support means so as to be pivotable about their longitudinal axes. Said slats are individually suspended separately from each other.

A similar arrangement is described in DE 83 03 847 U1. In this document, too, slats for curtains for shielding X-ray radiation are disclosed, wherein the slats consist of a continuous lead plate coated on both sides with a plastic material.

DE 93 13 473 U1 also describes a horizontally displaceable X-ray protective slat curtain. The curtain can be adjusted into an opened and a closed position. The slats are individually suspended. To this end, the slats are hooked into slat hooks by means of rectangular mounting apertures at their upper ends. A movement mechanism is provided in a guide and fixing rail by means of which the slats can be displaced along the rail and along which the slats are rotatable by 180°. The movement mechanism is operable via cords or an electric motor. The individual slats consist of a plate-shaped lead insert which is covered with a plastic material on both sides.

DE 200 08 768 U1 describes a shielding wall, in particular against radioactive radiation, which consists of positively interlocking stackable elements. A displacement of the individual elements is not provided for. This is rather a stationarily standing shielding wall.

DE 200 13 658 U1 describes a radiation protective slat curtain in which individual slats are assigned to one carriage each. The slat is suspended from this carriage so as to be rotatable around its longitudinal axis. All carriages are arranged in rows in a supporting profile, wherein two adjacent carriages at a time are configured as a scissor-type hinge comprising two hinge levers hinged at one of their ends on one another and hinged at the other of their ends on one of the carriages. The hinge levers of every scissor-type hinge are adjustable between a first final position with an acute angle and a second final position with an obtuse angle. The radiation protective slat curtain comprises two drive systems, wherein a first drive system is provided for opening and closing the curtain and a second drive system is provided for adjusting the slats. A similar design is disclosed in DE 201 12 678 U1.

A further radiation protective device is described, for example, in DE 297 06 321 U1. This device consists of an upper and a lower part. The upper part comprises an optically transparent protective glass, whereas the lower part consists of a flexible material forming the protective curtain. The protective glass may be inclined relative to the vertical in the patient's direction. The slats forming the protective curtain may comprise a band by means of which each slat can be attached to a matching part provided at the fixing rail.

DE 297 22 765 U1 relates to a slat for a radiation protective slat curtain. It is, i.a., suggested that a lead insert be inserted into a cavity and held therein.

WO 2006/079472 A1 describes a radiation shielded door, in particular for an X-ray inspection system as used, for example, at airports. This radiation shielded door comprises plates whose end faces represent levers which are joined in the way of lazy tongs. The plates can be adjusted between an open position and a closed position. A lead flap can be provided at one edge of a plate, said lead flap being intended to ensure that the transition region between two plates is covered in the closed state of the door.

It is an object of the present invention to provide an improved radiation protective slat arrangement which enables an improved radiation protection and a flexible use. This object is achieved with the features of the claims.

The invention is based on the basic idea of providing a radiation protective slat arrangement according to the principle of a folding curtain so that a substantially completely closed radiation protective area is provided. To this end, the radiation protective slat arrangement comprises a guide and several radiation protective slats movably arranged along the guide. The arrangement can be converted from an open state to a closed state by displacing and rotating the slats, wherein adjacent slats overlap each other and are articulated to each other so as to form the folding curtain.

The overlapping and articulated arrangement of adjacent slats ensures that the radiation protective slat arrangement according to the invention prevents radiation from escaping. Furthermore, the connection of the individual slats with one another guarantees that nothing can get between the slats and that thus radiation can be effectively prevented from accidentally escaping.

Preferably, the slats are arranged to overlap in such a way that a substantially closed radiation protective area is formed in every position and/or orientation of the slats. This is in particular advantageous in that one and the same radiation protective slat arrangement can be used for travel paths of different lengths. This ensures a flexible use. The adjacent slats preferably enclose an angle which may vary between 5° (open radiation protection) and 160° (closed radiation protection), preferably between 15° and 145°. The slats are preferably arranged to overlap such that a closed radiation protective area is formed if the angle is greater than 100°, preferably greater than 120°. Preferably, a closed radiation protective area is further formed when the enclosed angles are smaller than 80°, preferably smaller than 60°.

It is further preferred to configure at least one longitudinal side of a respective slat so as to be angled. The angle within the slat and the maximum angle formed between adjacent slats preferably correspond to each other so that the adjacent slat gets to rest substantially parallel to the angled area when the radiation protection is completely closed. Two adjacent slats are preferably configured so as to differ in their shape and/or size. It is preferred to use a first, relatively broad slat which is angled in opposite directions at its two opposing longitudinal sides. A second, narrower slat preferably not being angled is arranged adjacent to such a broad slat.

Adjacent slats are preferably connected to each other by removably attached pivot pins. Such a modular structure permits the individual replacement of any damaged slats, which ensures short downtimes.

Each of the slats preferably comprises two cover elements between which a cavity is formed for accommodating a radiopaque material and an optional filling material. Alternatively, it is possible to configure the slats as closed hollow moulds into which the radiopaque material is introduced. Preferably, the two cover elements of the slats are designed substantially identically and arranged point-symmetrically with respect to each other. It is thus possible to produce the two cover elements so as to be identical in construction with a single mould. It is preferred that the two cover elements, the radiopaque material and the optional filling material are glued to one another. Additionally or alternatively, the cover elements may be connected to each other with positive locking or by means of additional fasteners.

The guide for the radiation protective slats is preferably configured as suspension for the slats. Each of the slats is preferably attached to the guide via a ball-and-socket joint or a universal joint. This involves in particular the advantage that in case of a deflection of the slats, for example when someone bumps against one or more of the slats, the guide is not damaged but the slats can be deflected. The guide for displacing and rotating the slats preferably comprises lazy tongs.

The radiation protective slats are preferably driven by means of a motor. On account of the fact that they are guided and connected with the motor, the slats simultaneously perform a translational and rotational movement. Alternatively or additionally, the drive can be manually performed. To this end, for example, a crank mechanism can be provided for. Preferably, the manual operation mode is provided as emergency actuation so that the radiation protective slats can be opened even in case of a defect, for example an electrical power outage.

Preferably, the arrangement further comprises a final-position locking which permits to fix or lock the slats in their open and/or closed state. The final-position locking can comprise, for example, one or more magnets by means of which the final slat is fixed, for example, to an adjacent wall. Alternatively, however, it is also possible that mechanical latches or closures are used, such as, for example, a detent mechanism as used with ballpoint pens.

Advantageously, the radiation protective slat arrangement according to the invention can be provided with a means for communicating with an X-ray apparatus so that the X-ray apparatus is only operable when the radiation protective slat arrangement according to the invention is in its closed state and a respective signal is transmitted to the X-ray apparatus. Such a signal can be generated in a simple way according to the invention, namely always at the time when the radiation protective slat arrangement is in its closed position. To this end, an end switch can be used, for example, which not only deactivates the drive but simultaneously informs the X-ray apparatus that the arrangement is closed. Since the individual slats are arranged according to the invention in a way to be overlapping and articulated to each other such that they form a closed radiation protective area, such a simple control mechanism nevertheless is able to reliably guarantee that no radiation can escape through the radiation protective arrangement.

Although the invention is described in particular in connection with X-ray radiation, it is also appropriate for shielding other radiations, such as, for example, laser radiation.

The invention will be described in the following in more detail by means of a preferred embodiment with reference to the Figures.

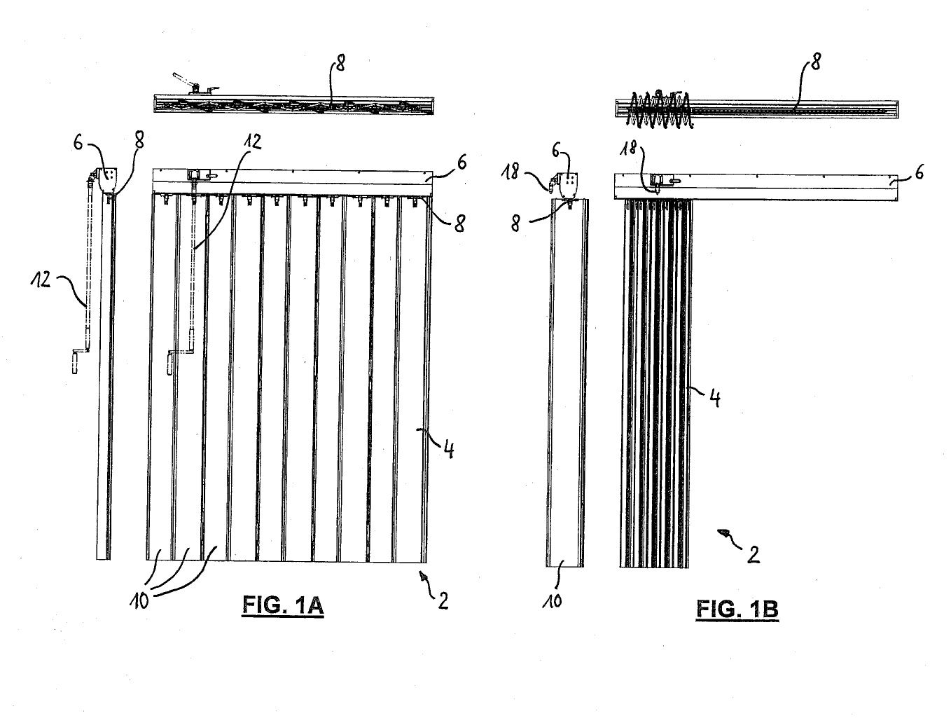

FIG. 1A shows a front view, side view and top view of a radiation protective slat arrangement according to the invention in its closed state;

FIG. 1B shows a front view, side view and top view of the radiation protective slat arrangement of FIG. 1A in its open state;

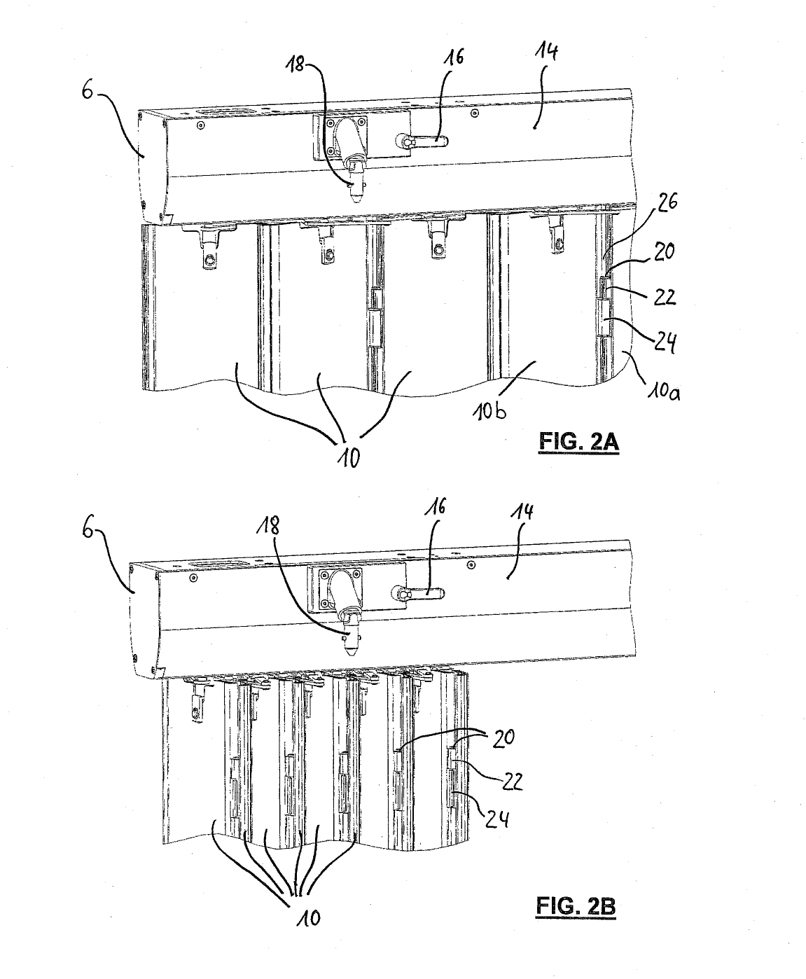

FIG. 2A shows a partial perspective detail view of a radiation protective slat arrangement according to the invention in its closed state;

FIG. 2B shows a partial perspective detail view similar to FIG. 2A, wherein the radiation protective slat arrangement is illustrated in its open state;

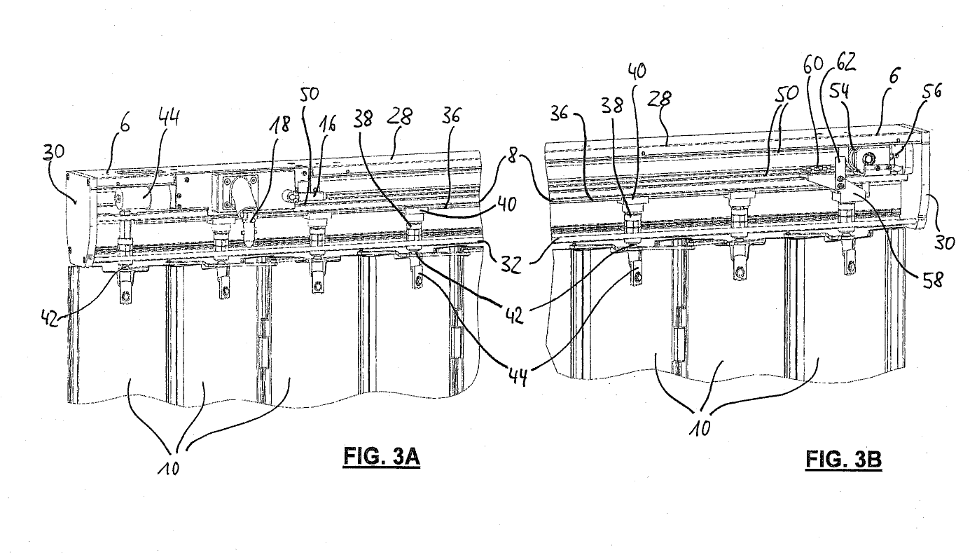

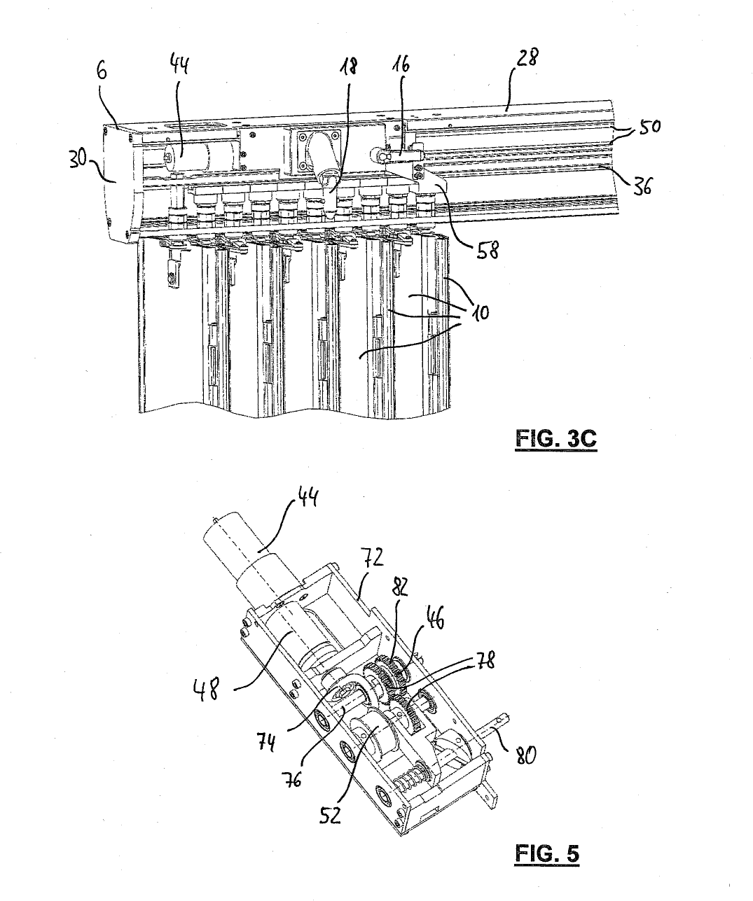

FIG. 3A shows a perspective detail view of a drive side of the radiation protective slat arrangement according to the invention similar to FIG. 2A, but with the housing cover being removed;

FIG. 3B shows a view similar to FIG. 3A, illustrating an end opposite the drive side in more detail;

FIG. 3C shows a view similar to FIG. 3A, but in its open state;

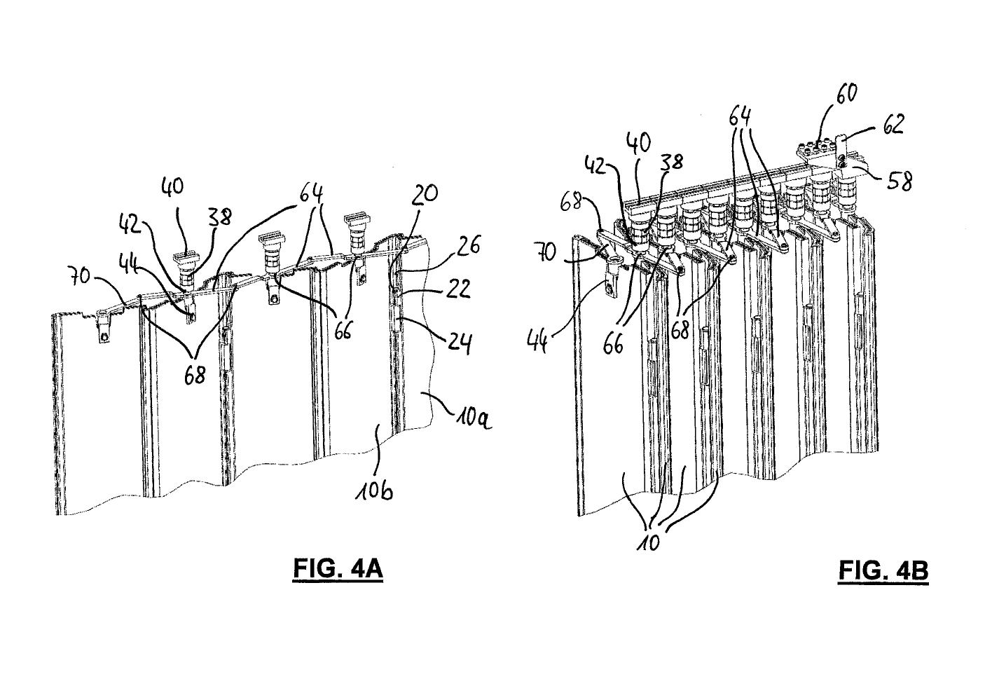

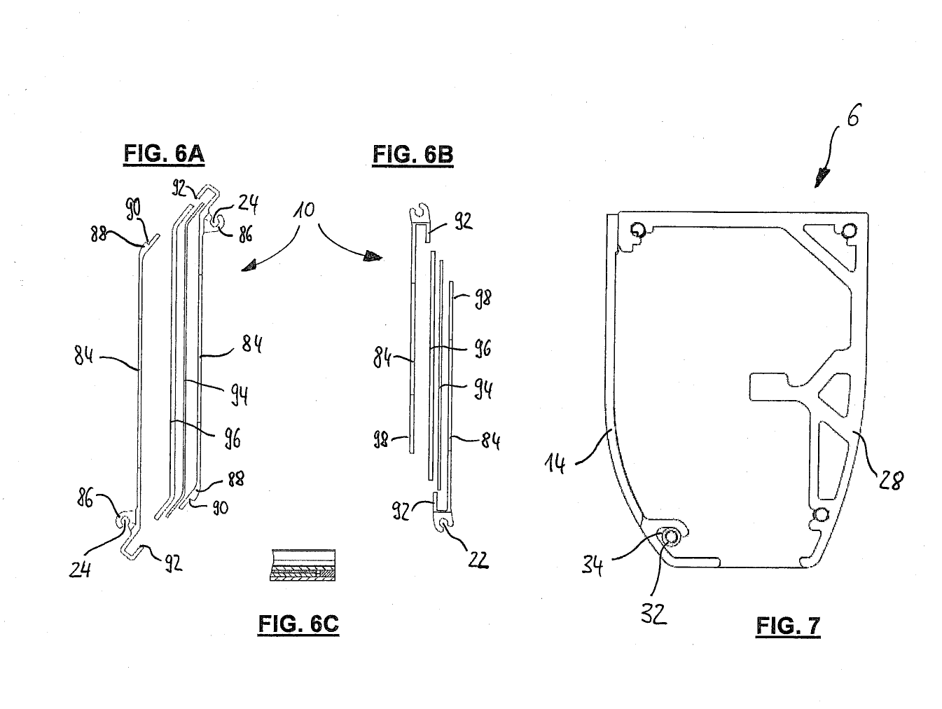

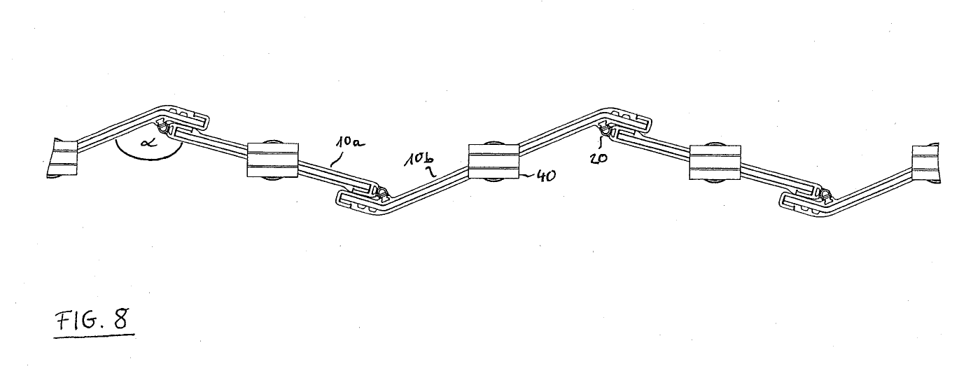

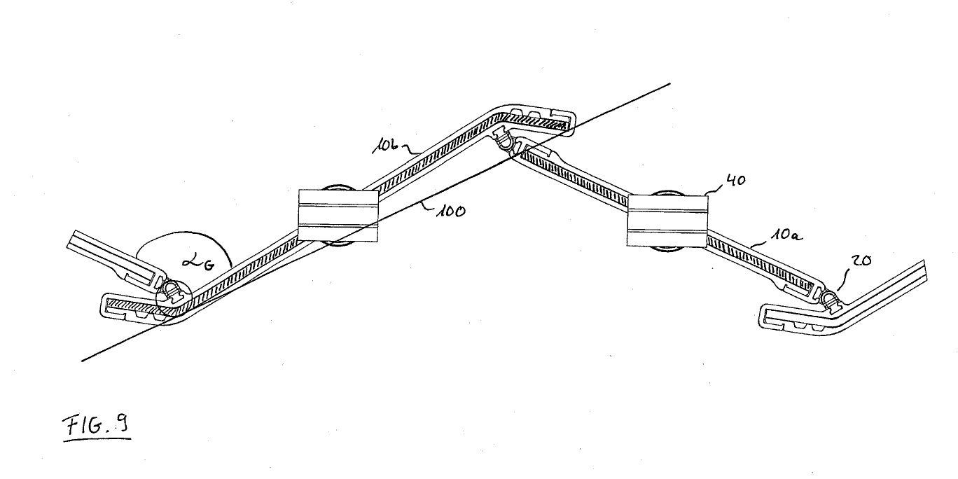

FIG. 4A shows a partial perspective view of the upper end of the slats with guide and drive elements in the closed state;

FIG. 4B shows a view similar to FIG. 4A in the open state;

FIG. 5 shows a perspective view of a drive and gear means used in the radiation protective slat arrangement according to the invention;

FIG. 6A shows an exploded side view of an individual component of a first slat type;

FIG. 6B shows an exploded side view of a second slat type;

FIG. 6C shows a cross-sectional view through the slat according to FIG. 6A;

FIG. 7 shows a side view of a housing for accommodating the drive and guide parts of the radiation protective slat arrangement according to the invention;

FIG. 8 shows a top view of a radiation protective slat arrangement according to the invention in its closed state;

FIG. 9 shows a top view of a radiation protective slat arrangement according to the invention in its partially closed state; and

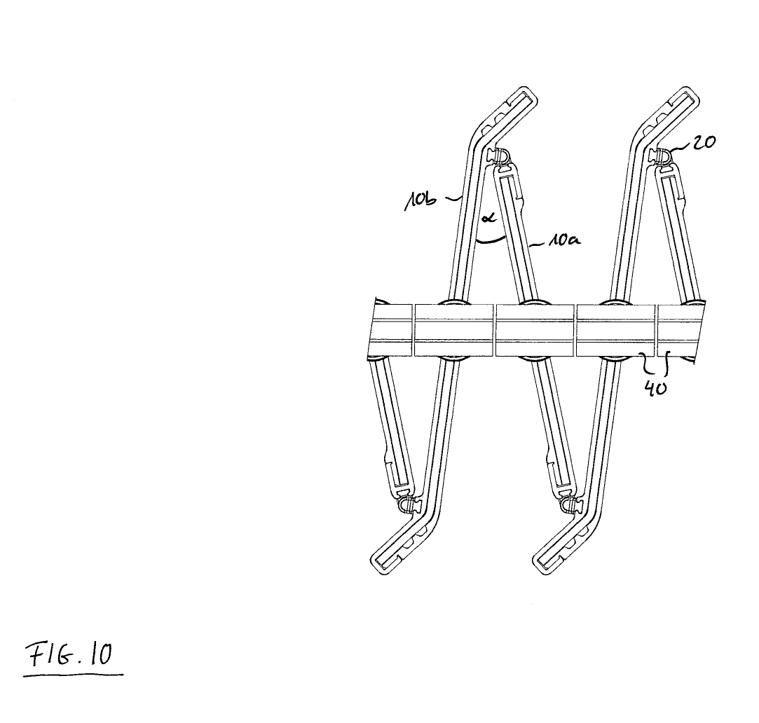

FIG. 10 shows a top view of a radiation protective slat arrangement according to the invention in its partially open state.

FIGS. 1A and 1B illustrate an embodiment of a radiation protective slat arrangement 2 according to the invention. In FIG. 1A a folding curtain 4 formed by the radiation protective slat arrangement 2 according to the invention is shown in its closed position whereas in the illustration according to FIG. 1B the folding curtain 4 is open.

The radiation protective slat arrangement 2 comprises a guide 8 which is arranged in the housing 6 and to which several movably arranged radiation protective slats 10 are attached. The radiation protective slat arrangement 2 can be converted from an open state according to FIG. 1B into a closed state according to FIG. 1A by displacing and rotating the slats 10. The different positions of the individual slats are apparent in particular when comparing the top views according to FIGS. 1A and 1B.

According to a preferred embodiment, the radiation protective slat arrangement 2 can be actuated by a drive mechanism which is arranged in the housing 6 and is illustrated in more detail in particular in FIG. 5. Alternatively or additionally, a manual actuation can be realized for example by means of a crank 12. Preferably, the crank 12 is only provided as emergency actuation, for example in case of an electrical power outage.

In FIGS. 2A and 2B, the radiation protective slat arrangement 2 according to the invention as illustrated in FIGS. 1A and 1B is shown in a perspective view in more detail. This view reveals in particular that the slats 10 form a substantially closed radiation protective area both in the closed state as shown in FIG. 2A and in the open state as shown in FIG. 2B. This is the case irrespective of the position and/or orientation of the slats 10.

FIGS. 2A and 2B further illustrate an emergency unlatching lever 16 at a side part 14 of the housing. By means of said unlatching lever 16, the slat arrangement 2 can be changed from automatic operation to manual operation. In the depicted position, for example, the arrangement is in the automatic operation. The arrangement can be changed to manual operation, for example, by rotating the lever 16 by 90° from the horizontal into the vertical or alternatively, for example, by pivoting the lever 16 by 180°. In the event that a manual operation is desired, the hand crank 12 can be engaged with a driving pin 18 in order to manually actuate the folding curtain 4. Alternatively, the slat arrangement 4 can be displaced by hand.

The individual adjacent slats 10 are articulated to each other according to the illustration in FIGS. 2A and 2B. To this end, for example, a releasable pivot pin 20 is provided. The individual pivot pins 20 are inserted into accommodation openings 22 and 24 of adjacent slats 10 in order to pin-joint said slats on each other. In an advantageous embodiment, the accommodation openings 22 and 24 of the slats 10 are provided end-to-end in the slat profile, wherein merely a recess 26 is provided in the area of the pivot pin 20 through which the pivot pin 20 can be introduced into the accommodation openings 22 and 24. Alternatively, for example, a three-part plastic hinge comprising straight pins can be used instead of the pivot pins 20. In this case, the sides of the slat profiles do not have to be machined.

Hence, in the embodiment shown in FIG. 2A, for example, a slat 10a is connected to an adjacent slat 10b in the following way. The slat 10a comprises a substantially continuous profile in which the accommodation opening 22 is provided along the longitudinal edges. The profile is recessed in the area of the articulated joint to form an access opening 26, for example, by milling off the profile so that the pivot pin 20 can be introduced into the accommodation opening 22 of the slat 10a. The slat 10b, which is to be connected with the slat 10a, also comprises an accommodation profile for the pivot pin 20, said profile extending along the lateral edges and defining the accommodation opening 24. This profile is milled off substantially along a major part of the length of the slat 10b and only present in the pivot areas in which an accommodation opening 24 is required. In other words, the two profiles provided along the lateral edges of the slats 10a and 10b form complementarily matching projections engaging into each other so that their accommodation openings 22 and 24 can be arranged so as to be axially aligned relative to each other in order to accommodate the pivot pin 20. Additionally, the profile of the slat 10a is milled off, preferably above the accommodation opening 22, over a length corresponding to the length of the pivot pin 20 so that the pivot pin 20 can be introduced in an easily accessible way.

This design permits the replacement of individual slats 10 even when the system is mounted in that the pivot pins 20 of the respective slat are removed and the respective slat is removed from its accommodation.

As shown in FIG. 2A, adjacent slats are connected to each other alternately at a front side and rear side. Accordingly, it is probably advantageous to insert or remove the pivot pins on the one side of the folding curtain 4, for example, in the at least partially closed state while the pivot pins on the opposite side, for example, are preferably best accessible in the completely open state.

FIGS. 3A and 3B illustrate in particular the guide and the drive of the folding curtain according to the invention in more detail. FIG. 3A shows essentially the drive side while FIG. 3B shows the side opposite the drive side in more detail. As apparent from FIG. 3A, the housing has a housing profile 28 along the length of the radiation protective slat arrangement, said housing profile 28 being adapted to be mounted on a wall or ceiling. The housing profile 28 is preferably an aluminium extruded section and can be produced in any length. A cover plate 30 is provided at each of the two front ends of the housing profile 28, said cover plates 30 closing the housing 6 in the longitudinal direction. The housing 6 further comprises a preferably continuous accommodation bar 32 which is intended to accommodate the housing side part or the housing cover 14. As an alternative, only short pins (not illustrated) are provided to accommodate the housing cover 14. Compared to a continuous accommodation bar 32, pins have the advantage of being more easily accessible during assembly and maintenance. Preferably, the housing cover 14 (see FIGS. 2A, 2B and 7) is put with a groove 34 over the accommodation bar 32 and then folded upwards in order to close the housing cover 14 with the housing profile 28 by means of screws, for example. This arrangement permits easy accessibility of the inner housing 6 from the side, as is illustrated in FIGS. 3A and 3B.

A guide 8, which will be described in more detail in the following, is provided in the housing 6 for accommodating the slats 10. The guide 8 comprises in particular a guide rail 36 which substantially extends along the length of the housing profile 28 and on which the individual slats 10 are both longitudinally displaceable and rotatable by means of appropriate accommodations 38. Preferably, the accommodation 38 of the movably guided slats 10 comprises a guide element 40 being seated on the guide rail 36 and preferably including a linear bearing. The guide element 40 in turn is preferably connected to a slat accommodation 44 by means of a ball-and-socket joint or a universal joint 42. Preferably, specific bearings are provided for the universal or ball-and-socket joints in order to make allowances for the occurring forces, in particular the high shearing forces. By means of this attachment of the individual slats 10 to the guide rail 36, each of the slats 10 is mounted so as to be longitudinally movable along the guide rail 36, rotatable and, due to the universal or ball-and-socket joint 42, even pivotable.

Contrary to the remaining slats 10, the slat 10 depicted leftmost in FIG. 3A is not mounted so as to be movable along the guide rail 36 but is stationarily fitted directly to the housing profile 28. However, this slat is also arranged so as to be rotatable and, due to the universal or ball-and-socket joint 42, pivotable.

Preferably, an electric motor 44 is provided in the housing 6 for driving the radiation protective slat arrangement 2 according to the invention. Said electric motor 44 drives a drive element 50, for example a chain or a toothed belt, via a gear 46, which is shown in more detail in FIG. 5, as well as via a friction clutch 48 provided between the motor 44 and the gear 46. The drive element 50 extends from a driven shaft 52 of the gear substantially along the guide rail 36 up to a return pulley 54, which is illustrated in FIG. 3B. Preferably, a tensioner 56, by means of which the drive element 50 can be adjusted to an appropriate tension, is provided in the area of the return pulley 54.

Preferably, the slat 10 (right in FIG. 3B) most distant from and opposite the stationary slat (left in FIG. 3A) is connected to the drive element 50 via a sliding carriage 58 for transmitting the drive motion from the motor 44 to the slats 10 via the drive element 50. This can preferably be realized by a clamping 60. In the embodiment shown in FIG. 3B, the sliding carriage 58 is connected to the guide element 40 so that it can displace the slat most distant from and opposite the stationary slat in a smooth-running way in the axial direction. Preferably, a projection 62 is provided at the sliding carriage 58, wherein said projection 62 cooperates, for example, with a sensor for the limit stop of the folding curtain 4 when the folding curtain 4 arrives in its closed or open position.

The transmission of the drive motion from the distant slat 10 driven by the sliding carriage 58 to the remaining movable slats will be described in more detail in the following with reference to FIGS. 4A and 4B. FIGS. 4A and 4B illustrate in more detail the upper end portions of the slats comprising their accommodation and guide elements. As already explained above, an accommodation element 44 is attached at the upper end of the slat 10, said accommodation element 44 being connected to the guide element 40 via the universal or ball-and-socket joint 42 such that each of the slats can perform a rotating and a swivelling motion.

The guide element 40 guides the individual slats 10 along the guide rail 36. For the purpose of transmitting the motion of the slats from the slat set in motion by the sliding carriage 58 to the remaining movably mounted slats 10, said slats 10 are interconnected in the illustrated embodiment by articulated struts 64. Each of the articulated struts 64 comprises a through-hole 66 in its central portion through which an accommodation means of each slat 10 passes so that the articulated strut 64 is rotatable around the same axis of rotation as the respective associated slat. The articulated struts 64 of the movably mounted slats further comprise openings 68 at their two opposite ends at which adjacent articulated struts 64 are articulated or pin-jointed to each other.

All slats 10 are coupled together by this arrangement so that the linear motion transmitted by the sliding carriage 58 to the most distantly located slat 10 is substantially concurrently transmitted to each of the slats 10 by the articulated struts 64 so that all slats 10 are substantially concurrently set into longitudinal and rotating motions by the drive in order to close the folding curtain.

Only the non-displaceable slat 10, i.e. the slat 10 opposite the sliding carriage 58 in the area of the drive, thus undergoes a rotating motion and no longitudinal motion. The rotating motion is introduced by a shortened articulated arm 70 which is connected to the adjacent articulated arm 64, as is illustrated in FIGS. 4A and 4B.

In the following, a preferred gear 46 is explained with reference to the exemplary FIG. 5. As shown in FIG. 5, the electric motor 44 is attached to a gear housing 72 and connected to the friction clutch 48 disposed in the housing 72. The rotating motion of the motor is transmitted to an input shaft 76 via the friction clutch 48 by means of a bevel gear 74. The input shaft 76 is in rotational communication with the driven shaft 52 via a gear pair 78, wherein the driven shaft 52 is set into an appropriate output speed. In the event that the emergency unlatching lever 16 is actuated, the gear of the gear pair 78 that is provided on the driven shaft 52 is displaced by the rotation of the lever 16 via a shaft 80 such that it engages with a gear 82. The gear 82 is mounted on a shaft that is in rotational communication with the pin 18 (FIG. 3C) so that upon rotation of the pin 18, for example by the hand crank 12, the driven shaft 52 can be set into rotating motion in order to move the folding curtain via the drive element 50.

FIGS. 6A, 6B and 6C illustrate in more detail slats 10 to be used in the radiation protective slat arrangement 2 according to the invention. The slat 10 depicted in FIG. 6A is a first type of slat used in the arrangement 2 according to the invention. This first type of slat essentially comprises two identical cover elements 84 which are arranged point-symmetrically with respect to each other and can be configured, for example, as aluminium extruded sections. The cover elements 84 comprise bendings in opposite directions along their longitudinal edges. In the area of one of the bendings, a profile projection 86 is provided which forms the accommodation opening 24 for the pivot pin 20.

In the depicted embodiment, the cover element 84 further is U-shaped in the area of this bending. A stop 88 and a recess 90 are provided at the opposite bending. The stop 88 and the recess 90 are adapted to engage with an end portion 92 of the U-shaped projection of the other cover element 84. The two cover elements can thereby be anchored or interlocked with each other and provide a positive fit. A cavity is formed between the two cover elements 84 in their assembled state, wherein a radiopaque material 94 and an optional filler layer 96 are inserted into said cavity. In the case of X-rays, for example, the radiopaque material can be a lead layer. The filler material 96 is only provided to fill up the cavity where necessary. This means that the filler material 96 is obsolete if the radiopaque layer 94 fills up the entire cavity. Preferably the individual layers 84, 94, 96, 84 are glued to one another in order to provide a stable slat 10. This is illustrated, for example, in FIG. 6C in a cross-sectional view.

In FIG. 6B, a second type of slat 10 is depicted, which again consists of two identical cover elements 84 defining a cavity between each other in which a radiopaque material 94 and an optional filler material 96 are arranged. The cover elements 84 according to FIG. 6B also have U-shaped end portions 92 but in contrast to the variant of the first kind of slat as shown in FIG. 6A they are not bent. At the end of each U-shaped end portion again a hook-in projection is provided which engages with a groove 98 in the cover element 84.

A profile projection 86 is formed along the length of the cover elements at each of the U-shaped end portions 92, said profile projections 86 defining the accommodation opening 22 for the pivot pin 20 intended for connecting adjacent slats 10. The individual layers 84, 94, 96, 84 of the second type of slats 10 according to FIG. 6B are again preferably glued to one another, wherein the projections hook into the grooves 98 and additionally provide preferably a positive connection.

In the embodiment of the radiation protective slat arrangement according to the invention as illustrated in the Figures, adjacent slats 10 of the first type according to FIG. 6A and of the second type according to FIG. 6B alternate with each other. Preferably, the first type of slats is a little wider than the second type of slats, as illustrated in FIGS. 6A and 6B. The width of the slats is preferably in the range between 20 and 900 mm, particularly preferred between 100 and 300 mm.

An alternative embodiment of a radiation protective slat arrangement according to the invention is shown in FIGS. 8 to 10. FIG. 8 illustrates a folding curtain formed by the radiation protective slat arrangement according to the invention in its closed position, while the folding curtain in the illustration according to FIGS. 9 and 10 is partially closed or open. As can be clearly seen in FIG. 10, every two adjacent slats 10a and 10b form an acute angle α in the state of the closed curtain, wherein depending on the design and arrangement of the joint 20 said angle α can be smaller than 30°, preferably smaller than 15°, in the completely closed state. In the completely open state, the angle α opens to more than 120°, preferably about 125° to about 130°, in some embodiments, however, even to 140°, 150° or 160°.

It is further preferred that at least one longitudinal side of a respective slat is angled. In the embodiment of FIGS. 8 to 10, both longitudinal sides of the one type of slats 10b are angled, whereas the second type of slats 10a adjacent to the first type of slats is not angled. The slats 10a alternate with the slats 10b within the curtain. The angle of the angled area within the slat and the maximum angle α formed between adjacent slats preferably correspond to each other in such a way that when the radiation protection is completely closed (cf. FIG. 8) the adjacent slat comes to rest substantially parallel to the angled area.

It is preferred that the slats 10a and 10b are arranged to overlap in such a way that a closed radiation protective area is formed from a limiting angle α_{G} onwards. FIG. 9 depicts a situation in which exactly this limiting angle is adjusted: In this situation, there is exactly one direction for the radiation 100 to pass between the radiopaque material (illustrated with hatching) of the slats 10a and 10b. When the curtain is closed to a greater extent, i.e. when α becomes greater than the limiting angle α_{G}, no radiation can pass through the curtain any longer. Preferably, a radiation protective area within this meaning is formed with angles α of greater than 100°, particularly preferably with angles of greater than 120°. As apparent from FIG. 9, the range of angles at which a complete protection can be achieved can be adjusted in that the angles within the slat as well as the length of the angled areas is varied. The dimensions of the articulation have an influence, as well.

Although the radiation protective slat arrangement according to the invention is illustrated with perpendicular slats 10, the slats 10 can also be in a horizontal or any other arrangement.

On account of its configuration, the radiation protective slat arrangement according to the invention can be flexibly used and in particular can be used for radiation protective applications, for example as a room divider or for covering window recesses. According to the invention, radiation is effectively prevented from passing or escaping through the slats 10 so that a flexible, reliably operating system is provided.

1. A radiation protective slat arrangement for shielding X-ray radiation comprising a guide and several radiation protective slats movably arranged along the guide, wherein the arrangement can be converted from an open state into a closed state by displacing and rotating the slats, wherein adjacent slats overlap each other and are articulated to each other and wherein the adjacent slats enclose a variable angle.

2. The radiation protective slat arrangement according to claim 1, wherein the adjacent slats enclose an angle which can vary between 5° and 160°.

3. The radiation protective slat arrangement according to claim 2, wherein the slats are arranged to overlap each other such that a closed radiation protective area is formed if the angle is greater than 100°.

4. The radiation protective slat arrangement according to claim 1, wherein at least one longitudinal side of the slats is angled.

5. The radiation protective slat arrangement according to claim 1, wherein the arrangement comprises slats of a first type and slats of a second type and wherein the slats of the first type are angled on both longitudinal sides and the slats of the second type are substantially planar.

6. The radiation protective slat arrangement according to claim 1, wherein adjacent slats are connected to each other by detachable pivot pins.

7. The radiation protective slat arrangement according to claim 1, wherein each of the slats comprises two cover elements between which a cavity is formed for accommodating a radiopaque material and an optional filling material.

8. The radiation protective slat arrangement according to claim 7, wherein the two cover elements are essentially identical and are arranged point-symmetrically with respect to each other.

9. The radiation protective slat arrangement according to claim 6, wherein the cover elements, the radiopaque material and the optional filling material are glued to one another and wherein the cover elements optionally are additionally connected to each other with positive locking.

10. The radiation protective slat arrangement according to claim 1, wherein adjacent slats differ in shape and/or size.

11. The radiation protective slat arrangement according to claim 1, wherein the guide is configured as suspension for the slats.

12. The radiation protective slat arrangement according to claim 1, wherein each of the slats is attached to the guide by a ball-and-socket joint or a universal joint.

13. The radiation protective slat arrangement according to claim 1, wherein the displacement and rotation of the slats is performed with a motor and alternatively manually.

14. An X-ray apparatus in combination with a radiation protective slat arrangement according to claim 1 comprising a means for the communication between the X-ray apparatus and the radiation protective slat arrangement, wherein the X-ray apparatus is only operable when the arrangement according to the invention is in its closed state.

15. The radiation protective slat arrangement according to claim 1, wherein the adjacent slats enclose an angle which can vary between 15° and 145°.

16. The radiation protective slat arrangement according to claim 2, wherein the slats are arranged to overlap each other such that a closed radiation protective area is formed if the angle is greater than 120°.
